(19) United States
(12) Patent Application Publication
(10) Pub. No.: US 2024/0379309 A1
(43) Pub. Date: Nov. 14, 2024

(54) CONTACT CARRIER FOR A VACUUM SWITCH, VACUUM SWITCH AND PRODUCTION METHOD FOR A CONTACT CARRIER

(71) Applicant: Siemens Aktiengesellschaft, München (DE)

(72) Inventors: Frank Graskowski, Wandlitz (DE); Hermann Bödinger, München (DE); Carsten Schuh, Baldham (DE); Thomas Brauner, Berlin (DE); Kira Berdien Wüstenberg, Berlin (DE)

(21) Appl. No.: 18/691,953

(22) PCT Filed: Sep. 2, 2022
(86) PCT No.: PCT/EP2022/074414

§ 371 Date: Mar. 14, 2024

(30) Foreign Application Priority Data
Sep. 23, 2021 (DE) 10 2021 210 646.3

(51) Int. Cl. H01H 33/664; H01H 1/02; H01H 11/04

(52) U.S. Cl. CPC H01H 33/6642; H01H 1/0206; H01H 11/048

(57) ABSTRACT

A contact carrier of a contact element for a vacuum switch is provided, which includes predominantly of a first conductive material or composite material and has a plurality of inlets of a second material distributed over the circumference, which bring about the formation of a magnetic field and thereby a movement of an arising arc on a predefined path during a switching process of the vacuum switch, wherein the second material has a lower level of conductivity relative to the first material or composite material and is introduced into the first material during the shaping of the contact carrier basic form. A production method for a contact carrier of this type is also provided.

### CROSS-REFERENCE TO RELATED APPLICATIONS

This application claims priority to PCT Application No. PCT/EP2022/074414, having a filing date of Sep. 2, 2022, which claims priority to DE Application No. 10 2021 210 646.3, having a filing date of Sep. 23, 2021, the entire contents both of which are hereby incorporated by reference.

### FIELD OF TECHNOLOGY

The following invention relates to a novel contact carrier for a vacuum switch, to a vacuum switch with such a contact carrier, and to a production method for a contact carrier.

### BACKGROUND

So-called radial or axial magnetic field contacts (RMF or AMF contacts) are used in vacuum switches or vacuum tubes for the low, medium and high voltage range, particularly for switching off currents greater than a few kiloamperes. The structure, function and operating principles of such contact elements in conventional design are described in detail, for example, in the dissertation “Modellierung des Plasmas im Vakuum-Leistungsschalter unter Berücksichtigung axialer Magnetfelder” (“Modelling the plasma in a vacuum circuit breaker under consideration of axial magnetic fields”) by K. Jenkes-Botterweck, published in 2003 and available online at http://publications. rwth-aachen.de/record/58842.

Widely used designs are the spiral contact and the cup contact. In the case of the spiral contact, disclosed for example in DE102019216869A1 and in DE102017214805A1, the required magnetic field is generated by the geometric design of the contact disk itself; in the case of other contact forms, in particular in the case of the pot contact also known for example from DE102017214805A1, the magnetic field is formed by an additional coil former on which the contact disk is placed.

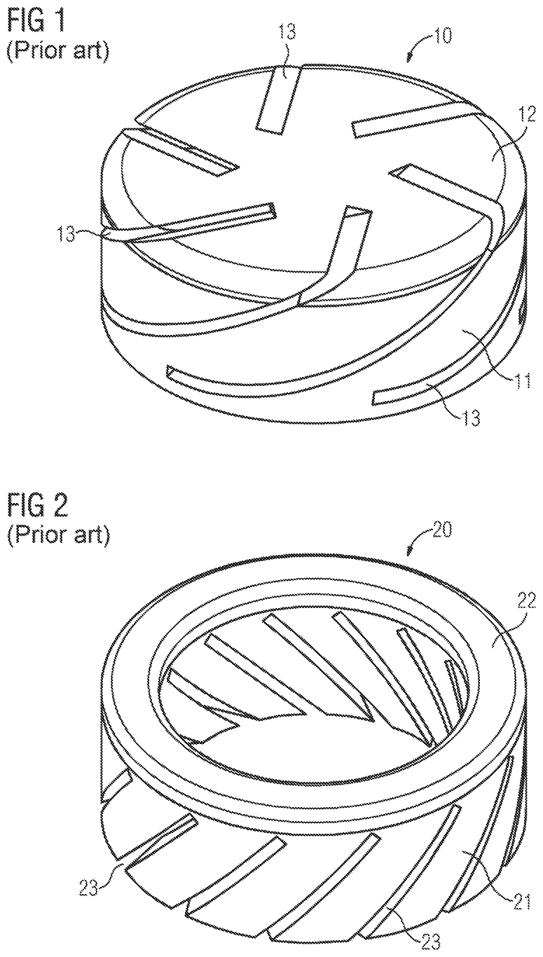

FIG. 1 shows a schematic representation of a conventional AMF contact 10. A contact carrier or coil former 11 carries a contact disk 12. The contact carrier and contact disk have a number of inclined slots 13 distributed over the circumference, which are made in the contact element in such a way that they (together with the geometry of the corresponding mating contact) cause the formation of an axial magnetic field and thus a large-area distribution of an arising arc on the contact disk.

FIG. 2 shows a conventional RMF contact 20 in schematic form. A contact carrier or coil former 21 carries an annular contact disk 22. The contact carrier 21 has a plurality of inclined slots 23 distributed over the circumference, which are formed in the contact body in such a way that they (together with the geometry of the corresponding mating contact) distribute the thermal load on the contacts by rotating the arc generated during switching processes about the longitudinal axis of the arrangement on the contact disks.

The coil formers are made here of copper rod material or of preformed copper compacts. The current flow control and thus the magnetic field generation through the coil former, which is often embodied as a hollow cylinder, is achieved through the aforementioned slots.

The disadvantage of this is that the slotting of the contact carrier or coil former significantly impairs its mechanical stability and in many cases requires a support body. In addition, the machining processes used to create the slots leave sharp edges and burrs that have to be rounded off or removed in additional work steps in order to prevent injuries when handling the coil formers and the finished contact elements. Sharp edges and burrs can also lead to localized increases in the electric field strength and thus have a negative effect on the dielectric strength of the vacuum switch. Furthermore, burrs can become detached under the influence of the electric field and/or due to mechanical vibration during the switching processes and can initiate an electrical breakdown in the vacuum switch.

A contact carrier is known from DE 33 02 595 A1, in which a body wound in a helical shape or provided with helical recesses is molded from a first material of lower electrical conductivity with a second material of higher conductivity and lower melting and casting temperature, wherein in particular the spaces between the helical windings or the recesses are molded. The body made from the first material forms part of the casting mold for the second material. The disadvantage of this is that the melting point of the first material must be significantly higher than the melting point of the second material and that the production of such a contact carrier takes a long time due to several sequential work steps.

### SUMMARY

An aspect relates to a contact carrier for vacuum switches as well as a production method for such a contact carrier, whereby the described disadvantages are avoided.

According to embodiments of the invention, this aspect is achieved by a contact carrier of a contact element for a vacuum switch, which consists predominantly of a first conductive material or composite material and has, distributed over the circumference, a plurality of inlets of a second material with a lower level of conductivity relative to the first material or composite material, which, in a switching process of the vacuum switch, cause the formation of a magnetic field and thus a movement of an arising arc on a predetermined path.

In other words, according to embodiments of the present invention, a material is embedded in the slot-shaped openings known from the conventional art, which has a lower level of conductivity compared to the material of the contact carrier, wherein the shape of the inlets is not limited to slots, but allows a significantly greater variety of shapes, which in turn enables optimizations of the magnetic field formation that cannot be realized with the classic cutting or machining processes or can only be realized with very high outlay.

The term “inlet” here means that the second material is introduced into the first material during the molding of the basic contact carrier mold and not subsequently, for example by making slots in a contact carrier which are then filled with the second material.

In embodiments of the invention, the first conductive material, i.e., the material of the contact carrier main body, is copper.

Stainless steel or another metal with a significantly lower level of conductivity than copper is used for the material embedded in the slots. In alternative embodiments, ceramics or ceramic-metal composites (cermets) are used as a second material.

A contact carrier according to embodiments of the invention can be produced, for example, by additive manufacturing processes (3D printing), in particular by a 2-component 3D printing process. The advantage of 3D printing is that the contact carrier, including the inlets, can be manufactured in a single operation and complex slot shapes can also be realized, which cannot be realized with conventional machining processes or only with great effort.

Embodiments of the present invention further relate to a vacuum switch comprising a vacuum chamber within which two contact elements are arranged, wherein at least one of the contact elements comprises a contact carrier according to the invention.

Embodiments of the present invention also relate to a method, as an alternative to 3D printing, for producing a contact carrier according to embodiments of the invention, which consists predominantly of a first material or composite material. One or more molded parts made of a second material with a lower level of conductivity relative to the first material or composite material are introduced into a powder bed, or a press die. The molded parts that primarily determine the shape of the contact carrier are then placed in the press die and a powder or green parts of the first material pre-compressed from powder are placed in the remaining free spaces. A pressing force is then applied so that the contact carrier with the embedded or inset molded parts is formed from the powder.

The powder can also be subjected to an electric current during the pressing process.

The voltage feed points and the electrical power fed in are selected here so that the currents flowing through the powder are approximately evenly distributed.

In an embodiment, a copper powder is used as powder. Stainless steel is the desired second material.

The molded part or parts are designed in such a way that, after pressing and sintering of the powder, they form recesses in the contact carrier distributed over the circumference, which, during a switching process of the vacuum switch, cause the formation of a magnetic field and thus the movement of an arising arc along a predetermined path.

### BRIEF DESCRIPTION

Some of the embodiments will be described in detail, with references to the following Figures, wherein like designations denote like members, wherein:

FIG. 1 shows a schematic representation of a conventional AMF contact:

FIG. 2 shows a conventional RMF contact in schematic form;

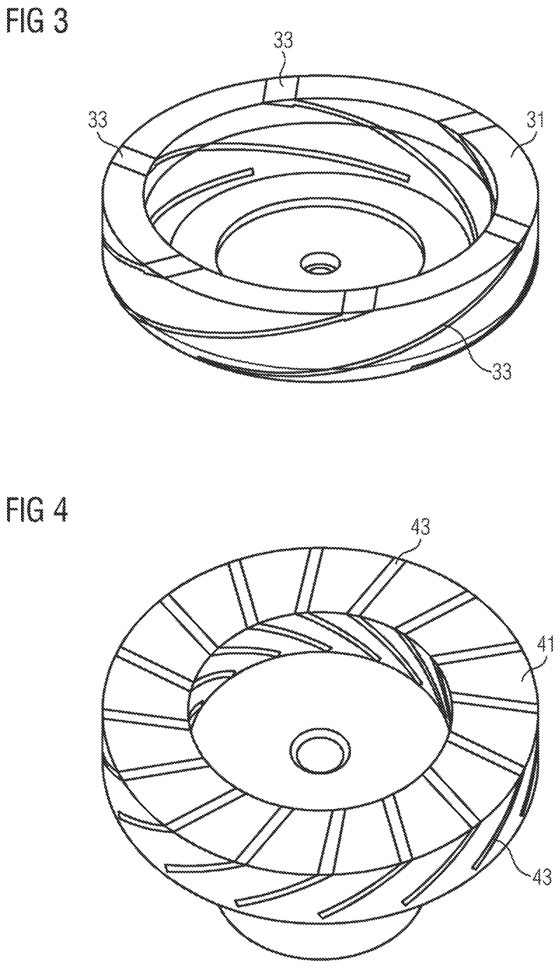

FIG. 3 shows a schematic perspective view of the contact carrier of an AMF contact according to an exemplary embodiment of the present invention:

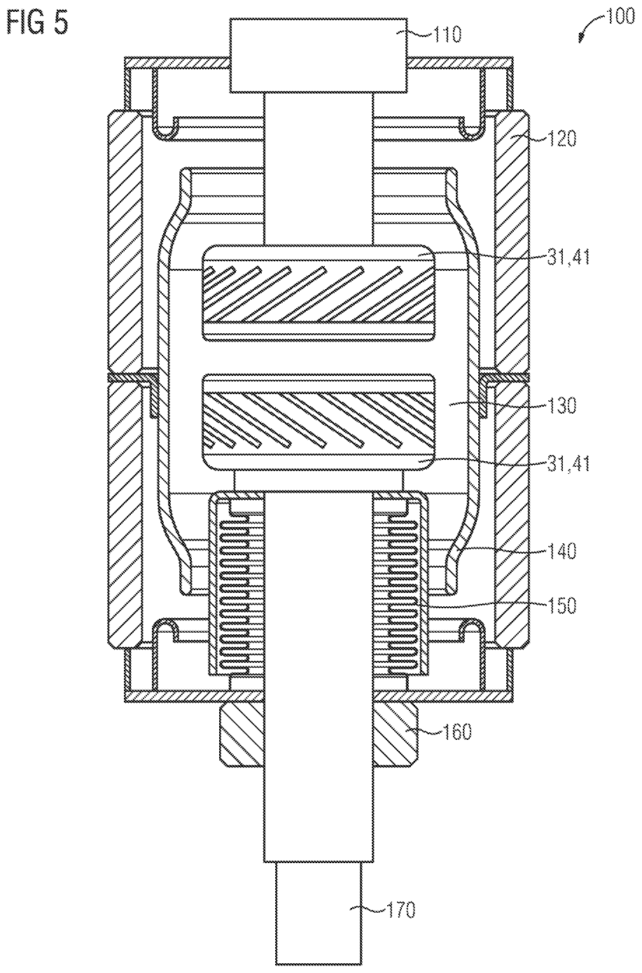

FIG. 4 shows a schematic perspective view of the contact carrier of an RMF contact according to an embodiment of the present invention: and

FIG. 5 shows a vacuum switch according to an exemplary embodiment of the present invention schematically in partial sectional view.

### DETAILED DESCRIPTION

FIG. 3 shows a coil former or contact carrier 31 of an AMF contact element for a vacuum switch 100 consisting of a first conductive material or composite material. The first conductive material is copper here. The contact disk is not shown in order to provide a clearer illustration of embodiments of the present invention.

However, it should be noted that the contact disk or a contact disk region can be attached to the surface of the contact carrier 31 or, in developments of embodiments of the present invention, can be formed in one piece with the contact carrier, more specifically on the surface of the contact element which is later to form the separable electrical connection of the vacuum switch.

The coil former 31 has a plurality of inclined inserts 33 distributed over the circumference, substantially slot-shaped in the example of FIG. 3, into which a second material with a lower level of electrical conductivity relative to the first material is inset, specifically in such a way that the inserts (together with the geometry of the inserts or slots of the actual contact disk, not shown in FIG. 3, and of the corresponding mating contact) cause the formation of an axial magnetic field and thus a large-area distribution of an arising arc on the contact disk.

FIG. 4 shows a coil former or contact carrier 41 of an RMF contact element for a vacuum switch 100 consisting of a first conductive material or composite material. The first conductive material is again copper here. In FIG. 4 as well, the contact disk is not shown in order to provide a clearer illustration of embodiments of the present invention.

However, it should be noted that an annular contact disk or an annular contact disk region can be attached to the surface of the contact carrier 41 or, in developments of embodiments of the present invention, can be formed in one piece with the contact carrier, namely on the surface of the contact element which is later to form the separable electrical connection of the vacuum switch.

The coil former 41 has a plurality of inclined inserts 43 distributed over the circumference, substantially slot-shaped in the example of FIG. 4, into which a second material with a lower level of electrical conductivity relative to the first material is inset, specifically in such a way that the inserts (together with the geometry of the inserts or slots of the corresponding mating contact) distribute the thermal load on the contacts by rotating the arc around the longitudinal axis of the arrangement on the contact disks.

FIG. 5 shows a vacuum switch 100 with two contacts with contact carriers 31, 41 according to embodiments of the present invention. Here, an RMF contact system with coil formers according to FIG. 4 is shown in detail purely by way of example. In other exemplary embodiments, AMF contacts according to FIG. 3 or other contact shapes designed in accordance with embodiments of the present invention are used.

The vacuum switch 100 has a fixed connection disk or a stationary connection bolt 110 made of conductive material, copper. This is connected to the coil former 31, 41 of a fixed contact. A movable contact is aligned plane-parallel to the fixed contact and is supported by a movable connecting bolt 170. Axial movement of the movable connecting bolt 170 in the direction of the fixed connecting bolt 110 closes the vacuum switch, while movement in the opposite direction opens the vacuum switch. The movable connecting bolt is guided here in a guide 160.

The two contacts are arranged here in a vacuum chamber 130, which is lined with a shield 140 and consists of a body 120 made of insulating material. A metal bellows 150, together with the guide 160, serves to seal the vacuum chamber 130 from the environment in the region where the movable connecting bolt passes into the vacuum chamber.

In the following, a desired production method for producing the contact carriers or coil formers 31, 41 is described.

One or more molded parts, made of stainless steel, which will later form the recesses in the copper coil former, are inserted into a die. The position of the molded parts is determined by suitable means. For example, a molded part can be used in which the several inlets, shown in plate form in the example of FIG. 3 and FIG. 4, are connected to each other by narrow webs that do not impair the later function and thus form an annular molded part that retains its shape when the powder is subsequently filled in.

Alternatively, a plurality of molded parts, which largely correspond to their final shape but protrude slightly beyond the later circumference of the contact element, can be inserted into corresponding holders in the die. The material of the molded parts that protrude beyond the circumference can then be removed during the final surface treatment of the contact element.

Copper powder is filled into the spaces between the die and surrounding the molded parts and subjected to a uniaxial pressure via press plungers. In an embodiment, an electric current flows through the sample to be sintered simultaneously via the press plungers and the die in a type of series connection. The resulting Joule heating of the sample or the die leads to very rapid heating of the sample and thus enables efficient sintering of the material.

The die may have an inner, cylindrical body around which the coil former 31, 41 is at least partially formed.

In exemplary embodiments of the present invention, the complete contact element including the contact disk can be produced by the sintering process in that a first powder-like mixture comprising particles of a first conductive material and particles of the second conductive material or a first prepressed, disk-shaped green body consisting of a composite of at least the first and the second conductive material is introduced into a pressing die. An inner press plunger is introduced into the die and the molded parts (as already described) are inserted into an intermediate space between the die and the inner press plunger and a second powder of the first conductive material or a second powder-like mixture comprising particles of the first conductive material or a second pre-pressed green body comprising the first conductive material is introduced. An outer press plunger is inserted into the space between the die and the inner press plunger. Pressing force is exerted on the outer and inner press plunger, specifically in such a way that a disk-shaped area forming the contact disk of the contact element is formed from the first powder-like mixture or the first green body and a region with inserts 33, 43 forming the contact body or contact carrier 31, 41 of the contact element is formed from the second powder or the second powder-like mixture or the second green body.

At the end of the SPS process, a contact carrier or contact element is available, the surfaces of which still have to be processed depending on the quality to be achieved, for example by polishing, for example to achieve a contact surface that is as flat and groove-free as possible. Compared to known methods, however, there is no need to slit the coil body or deburr the slits. In addition, compared to slitting processes, it is possible to design the molded parts in almost any shape and thus to optimize the magnetic field.

The advantage is that the sintered coil former or the sintered contact element is very close to the final contour, i.e. only a small amount of waste material is produced during final processing.

In embodiments of the present invention, it is possible to manufacture the coil former from a composite material by adding, instead of pure copper powder, a suitable powder mixture of copper and another material that exceeds the strength of copper in the sintered state. This can also be done locally, i.e., for example in regions of the coil former that are exposed to particular mechanical and/or electrical loads, such as the joints between the contact and the connecting bolt.

It should be noted here that only selected exemplary embodiments utilizing the present invention have been described here. In particular, it is possible, for example, to design and manufacture other forms of coil formers and contacts using the principles described herein. Similarly, while the materials described as desired are indeed desired, embodiments of the invention are not limited to these materials. Furthermore, as already mentioned, it is possible, for example, to choose an additive manufacturing process (3D printing) instead of the sintering process, for which most of the considerations and advantages disclosed in conjunction with the sintering process apply equally.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A contact carrier of a contact element for a vacuum switch, which comprises predominantly of a first conductive material or a composite material, wherein the contact carrier has a plurality of inlets of a second material distributed over a circumference, which bring about a formation of a magnetic field and thereby a movement of an arising arc on a predefined path during a switching process of the vacuum switch, wherein the second material has a lower level of conductivity relative to the first material or composite material and is introduced into the first material during the shaping of a contact carrier basic form.

2. The contact carrier as claimed in claim 1, in which the first conductive material is copper.

3. The contact carrier as claimed in claim 1, in which the second material is stainless steel.

4. A vacuum switch with a vacuum chamber, within which two contact elements are arranged, wherein at least one of the contact elements has a contact carrier as claimed in claim 1.

5. A method for producing a contact carrier of a contact element for a vacuum switch comprising: predominantly of a first conductive material, the method comprising:
inserting one or more molded parts made of a second material with a lower level of conductivity relative to the first material or composite material into a powder bed or a press die:
introducing one or more molded bodies and a powder of the first material into the powder bed or the press die; and exerting a pressing force so that the contact carrier is formed from the powder.

6. The method as claimed in claim 5, wherein the powder is additionally subjected to an electric current during the pressing process.

7. The method as claimed in claim 6, wherein voltage feed points and the electrical power fed in are selected in such a way that the currents flowing through the powder are approximately evenly distributed.

8. The method as claimed in claim 5, wherein the powder is a copper powder or a mixture of copper particles and a further conductive material.

9. The method as claimed in claim 5, wherein the second material is stainless steel.

10. The method as claimed in claim 5, wherein the molded part or parts are configured in such a way that, after pressing and sintering of the powder, the molded part or parts form inserts in the contact carrier which are distributed over a circumference and which, during a switching process of the vacuum switch, cause a formation of a magnetic field and thus a movement of an arising arc on a predetermined path.
